(19) United States
(12) Patent Application Publication
(10) Pub. No.: US 2008/0074893 A1
(43) Pub. Date: Mar. 27, 2008

(54) High bay lamp system having power reel control mechanism

(76) Inventor: Byung Il Ham, Rancho Pales Verdes, CA (US)

Correspondence Address: Walter T. Kim;Suite 1300, 2030 Main Street, Irvine, CA, 92614, US

(21) Appl. No.: 11/526,530

(22) Filed: Sep. 25, 2006

(51) Int. Cl. F21V 27/00

(52) U.S. Cl. 362/387; 362/386; 362/403

(57) ABSTRACT

A lamp system is disclosed for providing high-ceiling lighting. The lamp system includes a lamp assembly coupled to a reel assembly via an electrical cord. The reel assembly includes a motor coupled to a reel to provide rotational movement of the reel. The reel assembly is operable to rotate the reel in a first direction so as to wind the electrical cord disposed between the lamp assembly and the reel assembly about the reel to raise the lamp assembly. The reel assembly is further operable to rotate the reel in a second direction so as to unwind the electrical cord from the reel to lower the lamp assembly.

### BACKGROUND OF THE INVENTION

1. Field of the Invention

The present invention generally relates lamp systems, and more particularly, to high-bay lighting systems for use in high-ceiling areas.

2. Description of the Related Art

High bay light fixtures may be used to provide lighting in high-ceiling areas (e.g., more than 15 feet high) such as industrial manufacturing areas, warehouses, warehouse-type retailers, assembly areas, gymnasiums, hangars, transportation garages and the like. Light sources employed by the high bay light fixtures periodically need to be replaced. However, because the light sources used by the high bay light fixtures are located at elevations that are not easily accessible, the lamp replacement and other light fixture maintenances cannot be easily performed.

In certain cases, lift devices may need to be employed to position a user within arms reach from a high bay light fixture so as to enable performance of lamp replacement and other light fixture related maintenance services. The need to use the lift devices to perform lamp replacement or high bay light fixture repairs can significantly add to the time and cost required to accomplish such services. Additionally, industrial lift devices are typically high in cost and may not always be readily available in the high bay areas such as manufacturing areas, warehouse areas, gymnasiums, industrial garages, etc.

In cases where lift devices are not readily available, a user may need to utilize other available resources, such as stepladders or extension ladders. However, there is a risk associated with using stepladders or extension ladders to perform high bay lamp replacement services in that the user can fall from the ladder if the ladder becomes unstable or if the user loses his balance.

Accordingly, a need remains for a high bay lamp system that allows lamp replacement and other light fixture related maintenance services to be performed without incurring a risk of the person performing these tasks of falling off an unstable structure or the cost or time required of using lift devices.

### SUMMARY OF EMBODIMENTS THE INVENTION

According to an aspect of the present invention, at least one embodiment is directed to a lamp system suitable for high-ceiling lighting application. The lamp system includes a lamp assembly coupled to a reel assembly via an electrical cord. The reel assembly includes a motor coupled to a reel to provide rotational movement of the reel. The reel assembly is operable to rotate the reel in a first direction so as to wind the electrical cord disposed between the lamp assembly and the reel assembly about the reel to raise the lamp assembly. The reel assembly is further operable to rotate the reel in a second direction so as to unwind the electrical cord from the reel to lower the lamp assembly.

According to another aspect of the present invention, at least one embodiment is directed to a method including lowering a lamp assembly using a motor to rotate a reel in a first direction so as to unwind an electrical cord from the reel, and raising the lamp assembly using the motor to rotate in a second direction opposite to the first direction so as to wind the electrical cord about the reel.

According to a further aspect of the present invention, at least one embodiment of the present invention is directed to an apparatus including a lamp assembly having a base section capable of removably receiving a light source, and a mounting mechanism coupled to the lamp assembly to mount the lamp assembly to a mounting structure. In accordance with this embodiment, at least the light source is capable of being moved between an extended position in which at least the light source is lowered with respect to the mounting mechanism and a retracted position in which at least the light source is raised to a higher elevation than at the extended position.

### BRIEF DESCRIPTION OF THE DRAWINGS

Embodiments of the invention are illustrated by way of example and not by way of limitation in the figures of the accompanying drawings in which like references indicate similar elements. It should be noted that the references to “an embodiment” or “one embodiment” of this disclosure are not necessarily to the same embodiment, and such references mean at least one.

FIG. 1 is a view of a lamp system according to an embodiment of the present invention, illustrating a lamp assembly thereof raised to a retracted position.

FIG. 2 is a view of the lamp assembly shown in FIG. 1 lowered to an extended position.

FIG. 3 is a block diagram of a high bay lamp system according to an embodiment of the present invention.

FIG. 4 is a block diagram of a high bay lamp system according to another embodiment of the present invention.

### DETAILED DESCRIPTION OF THE INVENTION

In the following description, specific details are set forth in order to provide a thorough understanding of various embodiments of the present invention. However, it will be apparent to one skilled in the art that embodiments of the present invention may be practiced without these specific details. In other instances, well-known components, structures and techniques have not been shown in detail in order to avoid obscuring embodiments of the present invention.

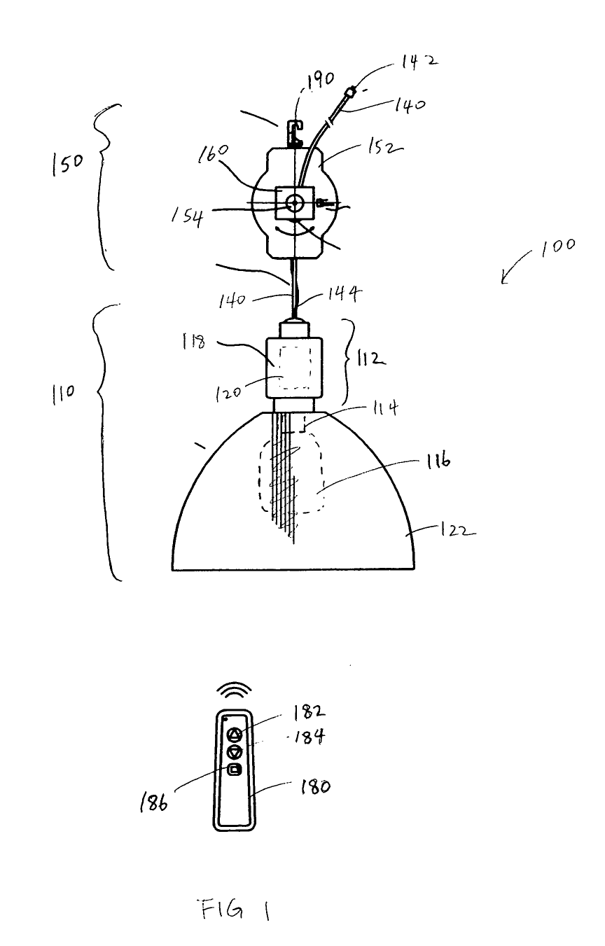

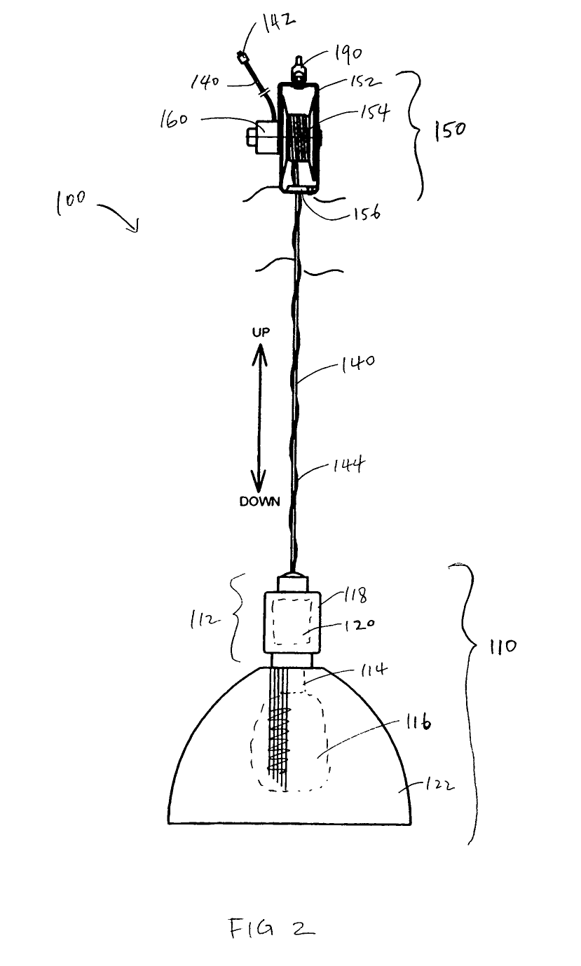

FIGS. 1 and 2 show a lamp system 100 according to an embodiment of the present invention. The lamp system 100 is suitable for high-ceiling application, for example, for use as a high bay light fixture to provide lighting in high-ceiling areas (e.g., more than 15 feet high) such as industrial manufacturing areas, warehouses, warehouse-type retailers, assembly areas, gymnasiums, hangars, transportation garages and the like. The lamp system 100 generally includes a lamp assembly 110 coupled to a reel assembly 120.

The lamp assembly 110 generally includes a base portion 112 having a socket 114 for receiving a light source 116. The base portion 112 comprises a ballast housing 118 and a ballast circuit 120 contained therein. Attached to the base portion 112 is a reflector member 122. The reflector member 122 is constructed of a suitable rigid material such as, for example, glass, plastic or metallic material with a coating disposed on its interior surface to achieve reflectance of light emitted by the light source 116. The reflector member 122 is shaped in any suitable form.

The lamp system 100 may employ any suitable type of light source including one or more fluorescent lamps or incandescent bulbs. However, to provide adequate amount of light from a distance required for high-bay applications, the lamp system 100 is preferably configured to employ one or more high intensity type lamps such as electrodeless induction lamps, high-output fluorescent lamps, or high-intensity discharge (HID) lamps (e.g., metal halide HID lamps, high-pressure sodium HID lamps, high pressure mercury vapor HID lamps).

The lamp system 100 is configured for securely mounting to a fixed structure in high-ceiling areas. In the illustrated embodiment, the reel assembly 150 is provided with a hook 190 for attaching to a coinciding mounting structure provided in a high-ceiling area.

The reel assembly 150 comprises a housing 152 and a reel 154 rotatably supported by the housing. An electrical power cord 140 is wounded around the reel 154. The electrical power cord 140 has a first end provided with an electrical plug 142 (e.g., a pair of electrical leads) for operative connection to an electrical power source, such as an AC socket (e.g., 110-volt power source). The electrical power cord 140 further includes a second end coupled to supply electrical power to the lamp assembly 110. More specifically, the second end of the electrical power cord 140 passes from the interior of the housing 152 to the exterior through an opening 156 formed in the housing 152 and is connected to the ballast circuit 120 contained in the base portion 112 to supply electrical power to the light source 116 employed by the lamp assembly 110.

In the reel assembly 150, the reel 154 is rotatable via an electric motor 160. The electrical motor 160 is coupled to the electrical cord 140 to receive electrical power. In use, the reel 154 is operative via the motor 160 and a motor controller to rotate in a first direction to wind the electrical cord 140 about the reel to raise the lamp assembly 110 to a retracted raised position (also referred to herein as a raised position), for example, as shown in FIG. 1. The reel 154 is also operable via the motor 160 and the motor controller to rotate in a second direction which is opposite the first direction to unwind the electrical cord 140 from the reel to lower the lamp assembly 110 to an extended position (also referred to herein as a lowered position), for example, as shown in FIG. 2.

In accordance with an aspect of the present invention, the lamp assembly 110 is normally maintained in the retracted position (raised position), as shown in FIG. 1, to deliver high intensity light from a high-ceiling elevation. However, in a case where lamp replacement or light fixture maintenance service is desired to be performed on the lamp assembly 110, the lamp assembly can be easily lowered using a remote control unit 180 to a lowered position as shown in FIG. 2. As shown in FIG. 1, the remote control unit 180 includes an up button 182, a down button 184 and a light on-off switch 186 that can be operated by a user to raise the lamp assembly, to lower the lamp assembly and to turn the light on and off.

In accordance with an aspect of an embodiment, a support line 144 wrapped around the electrical cord 140 to assist supporting the weight of the lamp assembly 100 and the electrical cord 140 disposed between the lamp assembly 110 and the reel assembly 150. Thus, the weight of the light assembly 110 is supported not only by the electrical cord 140 supplying electrical power to the light assembly but also a support cable or rope 144 wrapped around the electrical cord 140 is used to provided additional support. Although a rope or cable 144 is described as being employed to provide additional support, it is noted that any suitable line, including a string, a plastic line, a round cord, a flat cord that can provide additional support for supporting the weight of the light assembly 110 may be used.

While embodiments of the lamp system 100 are described as being used in high-ceiling indoor areas, it should be recognized that the lamp system 100 can be easily modified for outdoor use, such as for lighting streets, highways, parking lots, stadiums and the like.

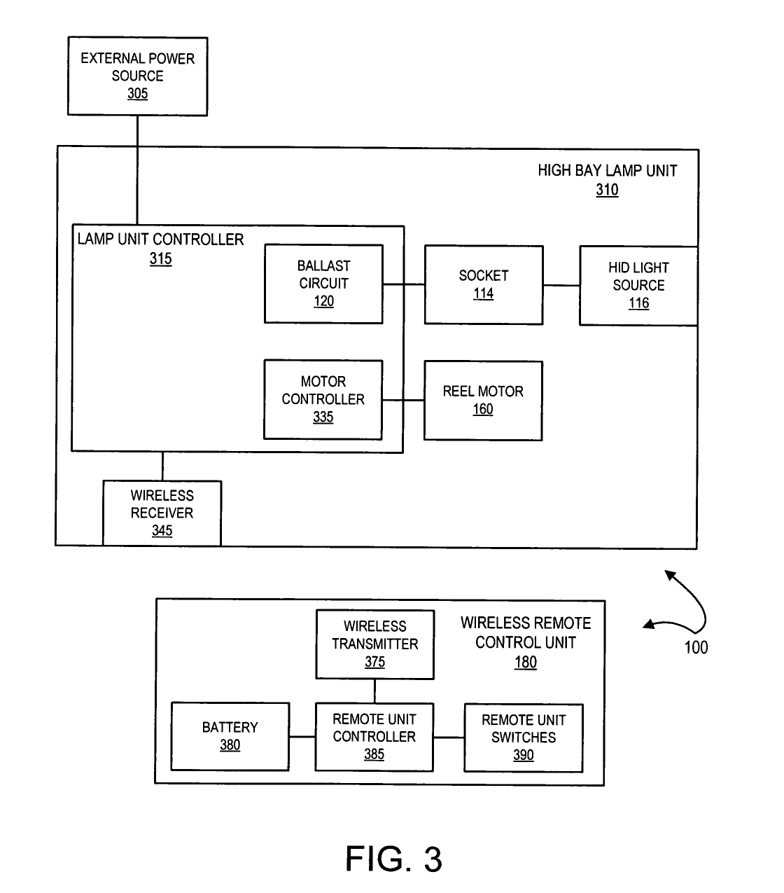

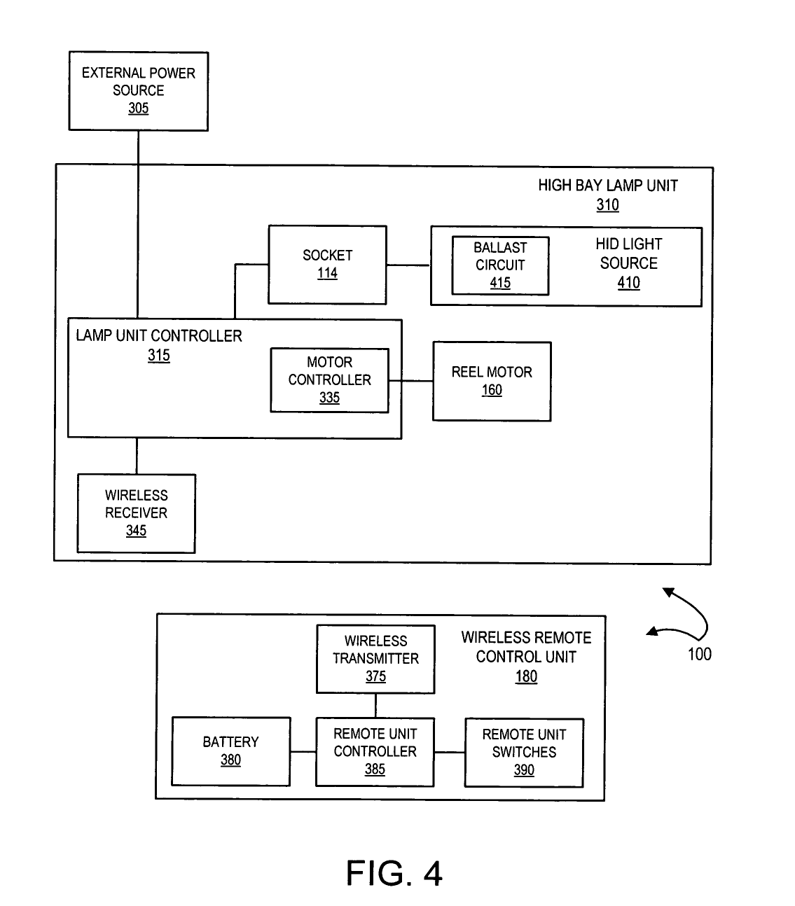

FIG. 3 is a block diagram of a lamp system 100 according to an embodiment of the present invention. The lamp system 100 generally comprises a high bay lamp unit 310 and a wireless remote control unit 180. In an embodiment, the high bay lamp unit 310 includes the lamp assembly 110 coupled the reel assembly 150 as described in reference to FIGS. 1 and 2. As described above, the lamp assembly 110 comprises a high-intensity discharge (HID) light source 116 removably coupled to a ballast circuit 120 via a socket 114. The electrical power required to operate the ballast circuit 120 and the HID light source 116 is supplied by an external power source 305 via an electrical cord 140. The ballast circuit 120 included in a lamp unit controller 315 is coupled to the socket 114 and is configured to drive the HID light source 116. For example, in an embodiment where the lamp unit 116 is configured for use with an electrodeless induction type lamp, the ballast circuit 120 is configured to generate high frequency power (e.g., high frequency current) to drive induction coil wound around the ferrite cores of the electrodeless lamp. Although in the embodiment illustrated in FIG. 3, the ballast circuit 120 is separate from the HID light source 116, it is noted that a ballast circuit 415 may be incorporated within a HID light source 410, as shown in the embodiment illustrated in FIG. 4.

As shown in FIGS. 3 and 4, the lamp unit 310 further comprises the reel motor 160 and a motor controller 335 to permit motorized operation of the reel assembly. The reel motor 340 is reversible to rotate the reel 154 in either rotational direction. The motor 340 is controlled by the motor controller 335 for positioning the lamp unit 310 in any elevation between the retracted position (e.g., as shown in FIG. 1) and the extended position (e.g. as shown in FIG. 2) as instructed by a user operating the remote control unit 180. The electrical power required to operate the motor 160 and the motor controller 335 is supplied by the external power source 305. In one embodiment, the lamp unit controller 315 enables and disables power supplied to the motor controller 335 and the ballast circuit 120 based on wireless signals received by a wireless receiver 345. Additionally, the lamp unit controller 315 is configured to instruct the motor controller to operate the motor to rotate in a rotational direction in accordance with a wireless instruction signal received by the wireless receiver 345.

In one embodiment, the motor controller 335 is coupled to the wireless receiver 345 to operate the reel motor 160 based on wireless signals received from the wireless remote control unit 180. Accordingly, as mentioned above, a user can selectively lower and raise the lamp assembly 110 using the switches 390 provided on the wireless remote control unit 180. In addition to the switches for controlling the reel motor 160, the remote control unit 180 includes a switch 186 (shown in FIG. 1) to allow the user to turn on and off the power delivered to the light source 116. As seen by referring to FIGS. 3 and 4, the remote control unit 180 comprises a wireless transmitter 375 coupled to a remote unit controller 385 and a battery 380 for transmitting wireless signals in accordance with user inputs received via the remote unit switches 390.

In use, when maintenance of the lamp assembly 110 is desired, for example, when the light source 116 needs to be replaced, a user can operate the down button 184 provided on the remote control unit 180 to operate the reel motor 160 to rotate in a direction so as to unwind the electrical cord from the reel to lower the lamp assembly 110 to a lowered position. When the maintenance of the lamp assembly 110 has been completed, the user can operate the up button 182 provided on the remote control unit 180 to operate the reel motor 160 to rotate in a direction so as to wind the electrical cord about the reel to raise the lamp assembly 1 10 to a raised high bay lamp position.

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

What is claimed is:

1. A system comprising:
a lamp assembly; and
a reel assembly coupled to the lamp assembly via an electrical cord, the reel assembly having a motor coupled to a reel to provide rotational movement of the reel, wherein the motor is operable to rotate the reel in a first direction so as to wind the electrical cord disposed between the lamp assembly and the reel assembly about the reel to raise the lamp assembly, the motor is further operable to rotate the reel in a second direction so as to unwind the electrical cord from the reel to lower the lamp assembly.

2. The system of claim 1, wherein the electrical cord has a first end provided with a connector removably connectable to an electrical power source and a second end coupled to supply electrical power to the lamp assembly, the electrical power cord further coupled to supply electrical power to the motor.

3. The system of claim 1, further comprising:
a support line wrapped around the electrical cord to assist supporting weight of the lamp assembly and the electrical cord disposed between the lamp assembly and the reel.

4. The system of claim 1, wherein the reel assembly further comprising:
a controller coupled between the motor and an electrical power source to electrically connect and disconnect the motor to and from the electrical power source and to control rotational direction of the motor based on an user input signal.

5. The system of claim 4, further comprising:
a wireless receiver coupled to the controller and capable of receiving wireless signals, wherein the motor is enabled and disabled based on a wireless signal received by the wireless receiver, wherein a rotation direction of the motor is controlled based on the wireless signal received by the wireless receiver.

6. The system of claim 4, wherein the reel assembly further includes an enclosure that contained the controller and the wireless receiver.

7. The system of claim 5, further comprising:
a wireless remote control unit having a wireless transmitter coupled to a user operable switch to transmit wireless signal based on a user input received via the user operable switch.

8. The system of claim 1, wherein the lamp assembly comprises:
a base portion including a ballast housing containing ballast circuit;
a socket coupled to the base portion, the socket capable of receiving a high-intensity discharge lamp; and
a reflector member coupled to the base portion to reflect light emitted by the high-intensity discharge lamp.

9. The system of claim 1, wherein the lamp assembly comprises:
a socket to receive a high-intensity discharge lamp having a ballast circuit contained within the lamp; and
a reflector member to reflect light emitted by the high-intensity discharge lamp.

10. A method comprising:
lowering at least a light source of a lamp assembly using a motor to rotate a reel in a first direction so as to unwind an electrical cord from the reel; and
raising the at least the light source of the lamp assembly using the motor to rotate in a second direction opposite to the first direction so as to wind the electrical cord about the reel.

11. The method of claim 10, wherein the lamp assembly includes a base section capable of removably receiving the light source.

12. The method of claim 1 1, further comprising:
using the electrical cord to connect the base section of the lamp assembly to the reel.

13. The method of claim 11, further comprising:
wrapping a support line around the electrical cord to assist support weight of the lamp assembly and the electrical cord disposed between the lamp assembly and the reel.

14. The method of claim 10, wherein the lamp assembly is mounted in a high-ceiling area to provide lighting from a ceiling elevation greater than fifteen feet.

15. The method of claim 10, further comprising:
receiving a wireless signal transmitted from a wireless remote control unit;
controlling the motor to rotate the reel in the first direction when a first signal is received from the remote control unit; and
controlling the motor to rotate the reel in the second direction when a second signal is received from the remote control unit.

16. The method of claim 14, further comprising:
enabling electrical power supplied to a light source of the lamp assembly when a third signal is received from the remote control unit; and
disabling electrical power supplied to the light source of the lamp assembly when a fourth signal is received from the remote control unit.

17. An apparatus comprising:
a lamp assembly capable of removably receiving a light source; and
a mechanism to move at least the light source between an extended position in which the at least the light source is lowered and a retracted position in which the at least the light source is raised to an elevation which is higher than at the extended position.

18. The apparatus of claim 17, further comprising:
a mounting mechanism coupled to the lamp assembly to mount the lamp assembly to a mounting structure.

19. The apparatus of claim 18, further comprising:
a lamp socket capable of removably receiving the light source; and
a base section coupled to the lamp socket.

20. The apparatus of claim 19, wherein the base section includes a ballast circuit.

21. The apparatus of claim 19, wherein the socket is capable of being moved between a retracted position in which the socket is located adjacent to the base section and an extended position in which the socket is lowered with respect to the base section.

22. The apparatus of claim 21, wherein the mechanism comprises a reel assembly coupled between the socket and the base section, wherein the reel assembly is operable to rotate a reel in a first direction so as to wind an electrical cord disposed between the socket and the reel assembly about the reel to raise the socket, the reel assembly is further operable to rotate the reel in a second direction so as to unwind the electrical cord from the reel to lower the socket.

23. The apparatus of claim 20, wherein the base section is capable of being moved between an extended position in which the base section is lowered with respect to the mounting mechanism and a retracted position in which the base section is raised to a higher elevation than at the extended position.

24. The apparatus of claim 23, wherein the mechanism comprises a reel assembly coupled between the base section and the mounting mechanism, wherein the reel assembly is operable to rotate a reel in a first direction so as to wind an electrical cord disposed between the base section and the reel assembly about the reel to raise the base section, the reel assembly is further operable to rotate the reel in a second direction so as to unwind the electrical cord from the reel to lower the base section.
